(19) United States
(12) Patent Application Publication
(10) Pub. No.: US 2004/0096293 A1
(43) Pub. Date: May 20, 2004

(54) Truss screw

(75) Inventor: John Tadich, Lyndhurst (AU)

Correspondence Address: SENNIGER POWERS LEAVITT AND ROEDEL, ONE METROPOLITAN SQUARE, 16TH FLOOR, ST LOUIS, MO, 63102, US

(73) Assignee: MiTek Holdings, Inc.

(21) Appl. No.: 10/665,965

(22) Filed: Sep. 18, 2003

Related U.S. Application Data
(60) Provisional application No. 60/412,117, filed on Sep. 19, 2002.

(51) Int. Cl. F16B 25/10

(52) U.S. Cl. 411/387.8

(57) ABSTRACT

A screw is disclosed which has a shank having a screw thread. A drill section is formed on the shank and extends from the tip of the shank to an intermediate position. The screw thread extends all of the way to the tip. The drill section includes a flute forming a flute edge which intersects the screw thread to form at least one thread tapping edge.

### CROSS-REFERENCE TO RELATED APPLICATION

This application claims the benefit of U.S. Provisional Application No. 60/412,117, filed Sep. 19, 2002.

### FIELD OF THE INVENTION

This invention relates to a screw and, in particular, but not exclusively to, a truss screw for connecting metal webs to top and bottom chords of a building truss.

### BACKGROUND OF THE INVENTION

Building trusses of the type disclosed in our International Patent Application No. PCT/US00/23367 are comprised of top and bottom timber chords which are joined by metal webs. The webs have tabs with preformed holes and the tabs sit flush with facing surfaces of the top and bottom chords. The tabs are connected to the chords by screws which pass through the openings and screw into the chords.

Many examples of prior art screws exist which include a screw thread and the ability to self-tap by the provision of a drilling component on the screw. However, none of the conventional configurations have been found to consistently form a reliable connection in all of the various species of timber.

The connections formed by some types of conventional screws have in some instances failed due to splitting of the timber chord or, in the case of other types of conventional screws, by the screw being easily pulled out of the chord, thereby releasing the tab from the chord. The reason for the former failure has been found to be due to spreading of the fibres of the timber chords as the screw is driven into the chords, and the latter problem has been found to be caused by the lack of ability of the screw thread to tap into the timber fibre and to pull the screw into the timber. This can cause the timber fibres to be stripped out, therefore resulting in the screw easily being pulled out of the timber chord.

### SUMMARY OF THE INVENTION

Among the several objects and features of the present invention may be noted the provision of a screw which overcomes these problems and can form a reliable connection of a metal web of a building truss to a chord of the truss; the provision of such a screw which simultaneously drills a bore and taps the bore; the provision of such a screw which cuts the bore to a size of a shank of the screw; the provision of such a screw which produces a firm connection to a work piece which prevents the screw from being easily pulled out of the work piece or splitting of the work piece.

In general, a screw according to the present invention comprises a shank, a head at one end of the shank and a tip at the other end of the shank, the shank having an outer surface. The shank is of substantially constant maximum radius between the head and the tip. A drill section is formed on the shank and extends from the tip to an intermediate position between the tip and the head. The drill section has at least one flute defining a bore cutting edge at the tip of the shank which extends from a radially inner position with respect to the shank to the outer surface of the shank. A screw thread is formed on the outer surface between the head and the tip and terminates at the bore cutting edge. The flute further forms a flute edge which intersects the screw thread between the tip and the intermediate position to form at least one thread tapping surface on the screw thread where the flute edge intersects the thread. When the screw is screwed into a work piece, the bore cutting edge drills a bore having a diameter substantially equal to the cross-sectional size of the shank, and the thread tapping surface cuts into the work piece to tap the bore and engage the screw thread with the work piece.

In another aspect, a self tapping screw of the present invention comprises a head, a tip, and a shank having an outer surface. A screw thread projects outward from the outer surface of the shank and extends from a start location between the head and the tip to the tip, the shank having a constant maximum radius at least from the start location to the tip. A drill section is generally at the tip of the screw. The drill section is defined by at least one flute formed in the tip and the shank. The flute defines a cutting edge on the tip for forming a bore having a diameter equal to the diameter of the shank from the start location to the tip. The flute further defines a thread tapping edge at the intersection of the flute with the thread at a position nearest to the tip.

Other objects and features of the present invention will be in part apparent and in part pointed out hereinafter.

### BRIEF DESCRIPTION OF THE DRAWINGS

A preferred embodiment of the invention will be described, by way of example, with reference to the accompanying drawings, in which:

FIG. 1 is a side view of the screw according to the preferred embodiment of the invention;

FIG. 2 is an end view of the screw of FIG. 1 along the line II-II of FIG. 1;

FIG. 3 is an enlarged view of part of FIG. 1.

FIG. 4 is a view similar to FIG. 2 but showing various lines A to D to illustrate the configuration of a clearance surface on the screw according to the preferred embodiment;

FIG. 5 is a view along the line A of FIG. 4;

FIG. 6 is a view along the line B of FIG. 4;

FIG. 7 is a view along the line C of FIG. 4; and

FIG. 8 is a view along the line D of FIG. 4.

### DETAILED DESCRIPTION OF THE PREFERRED EMBODIMENT

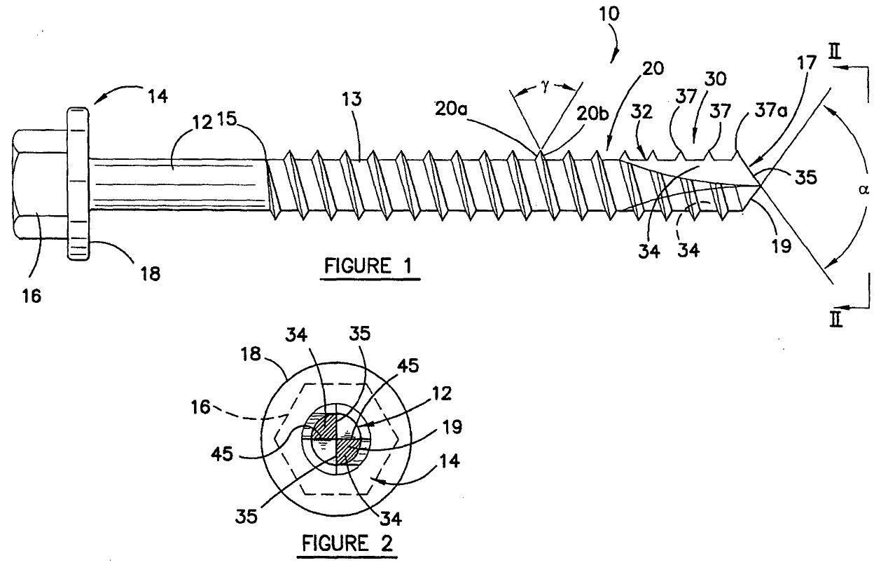

With reference to FIG. 1, a screw 10 is shown which has a shank 12 having an outer surface 13. A head 14 is formed at one end of the shank 12 and comprises a hexagonal nut 16 and an integral flange 18. The nut 16 is configured for receiving a tool such as a power operated driver (not shown), to rotate the screw 10 to drive the screw into a work piece (not shown) such as a timber chord of a building truss.

The screw 10 has a tip 17, at the end of the shank 12 opposite the head 14, which is formed by a generally conical surface 19. A screw thread 20 is provided on the outer surface 13 of the shank 12 and extends from a position 15 intermediate the head 14 and the tip 17 all of the way to the tip 17. The screw thread is triangular in cross-section and defined by inclined walls 20a and 20b.

The shank 12 is circular in cross-section and is of constant maximum radius (or diameter) from the head 14 all of the way to the tip 17.

A drill section 30 is formed on the shank 12 between the tip 17 and an intermediate position 32 between the tip 17 and the intermediate position 15.

The drill section 30 is formed after the thread 20 has been formed on the shank 12 by cutting a pair of flutes 34. The flutes 34 define a pair of bore cutting edges 35 and trailing edges 45 on the tip 17.

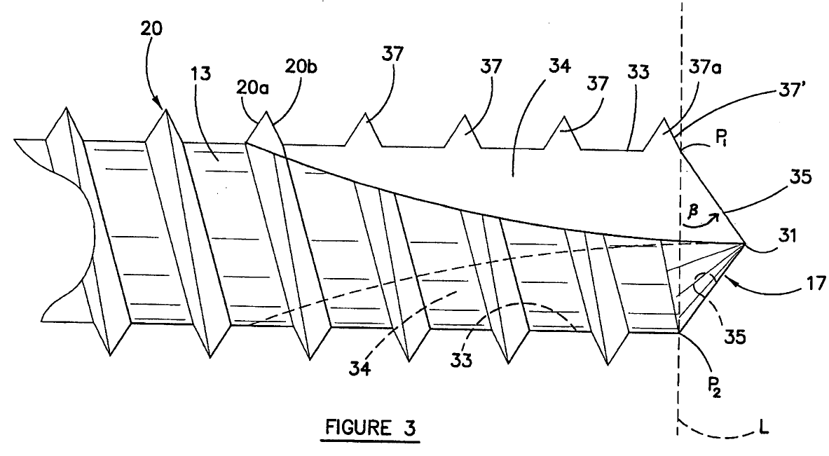

As best seen in the enlarged view of FIG. 3, the cutting edges 35 extends from an apex 31 of the tip 17 all of the way to the outer surface 13, as identified by points P1 and P2 in FIG. 3. The flutes 34 also define flute edges 33 which intersect the screw thread 20 on the shank 12 between the tip 17 and the intermediate position 32. The intersection of the flute edges 33 with the thread 20 forms thread tapping edges 37 on the thread 20.

Most preferably the pitch of the thread 20 is such that a plurality of thread tapping surfaces 37 will be formed by the intersection of the flute edges 33 and the thread 20. However, depending on the pitch of the thread 20 and the application, each flute edge 33 may intersect with the thread 20 to form only a single tapping surface 37 at each edge 33.

As is most clearly seen in the enlarged view of FIG. 3, the cutting edge 35 extends to point P1 as previously described, and a thread tapping edge 37′ of the thread tapping surface labelled 37a in FIG. 3 which is closest to the tip 17 is a continuation of the edge 35 but formed at a larger angle P with respect to a vertical line L (FIG. 3) perpendicular to the axis of the shank 12, than the edge 35.

The bore cutting edges 35 drill a bore (not shown) in the work piece (not shown), which has the same diameter as the shank 12 because the edges 35 extend to the outer surface 13 of the constant cross-section shank 12. Simultaneously with cutting of the bore by the bore cutting edges 35, the thread tapping surfaces 37 which intersect the flute edge 33 tap into the cylindrical wall of the bore in the work piece so the screw 10 is able to screw into the work piece with the remainder of the thread 20 following in the tap formed by the thread tapping surfaces 37.

Thus, the cutting of the bore is formed by the bore cutting edges 35 cutting a bore which has the diameter of the shank 12 so the shank 12 locates in the work piece. The fibres of the work piece adjacent the tapped bore are substantially undisturbed and therefore maintain their structural integrity. Furtherstill, the cutting of the bore of the same size as the shank 12 ensures that as the shank 12 locates in the work piece, the work piece is not split, which may otherwise be the case if no hole is drilled or if a bore is drilled which is substantially smaller than the actual diameter of the shank 12. As the bore is drilled, the tapping surfaces 37 are able to concurrently tap into the wall of the bore to engage the screw with the work piece because the thread 20 extends all the way to the tip 17. As mentioned above, the fibres in the vicinity of the bore are not disturbed and therefore maintain structural integrity so that the tapping of the thread into the wall of the bore forms a strong mechanical connection of the screw to the bore, therefore the screw firmly engages the work piece and will not pull out of the work piece, nor will the location of the screw cause splitting of the work piece.

The tapping surface labelled 37a in FIG. 3 which is closest to the tip 17 easily commences the tapping operation upon drilling of the bore by the bore cutting edge 35 because the tapping edge 37′ is an extension of the cutting edge 35. This facilitates easy cutting of the first thread cutting surface 37a into the wall of the bore as the bore is drilled by the bore cutting edge 35.

Wood which is cut from the timber as the bore is formed in the work piece, primarily compacts in the flutes 34.

As illustrated in FIG. 1, the tip 17 is in the form of a generally conical surface 19 which at the cutting edge 35 forms a cone angle a preferably in the range of 110 to 115°. The conical surface 19 forms a clearance surface which does not make contact with the wood of the work piece as the bore is being formed. Thus, contact is made by the cutting edge 35 of the tip 17 but the conical surface 19 effectively falls away from the cutting edge so it does not make contact with the work piece as the bore is being cut. The side surfaces 20a and 20b of the thread 20 preferably form an angle γ of 60° with respect to one another.

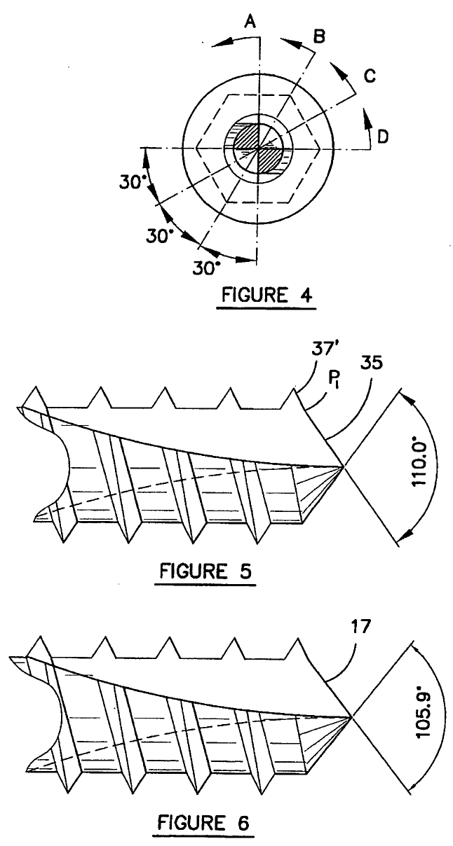

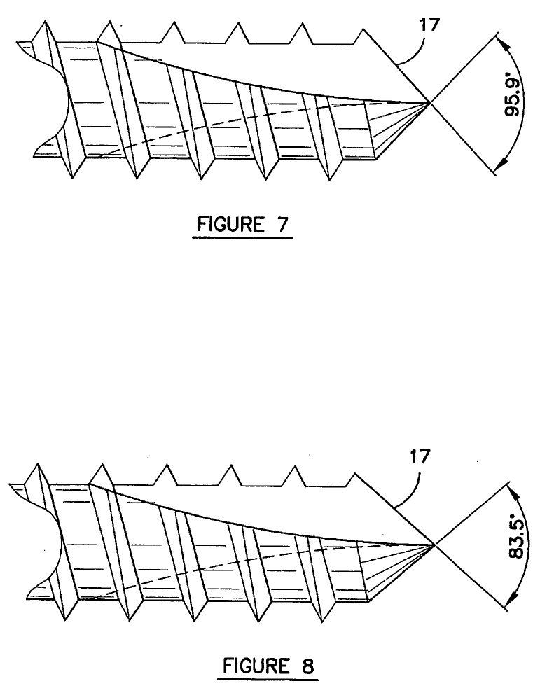

The manner in which the clearance surface falls away from the cutting edge towards the trailing edge 45 is best illustrated in FIGS. 4 to 8 by reference to lines A to D which are 30° apart. At the cutting edges 35 of the two flutes 34 the tip 17 is formed with a conical angle of, for example 110° at line A, at the line B which is rotated clockwise along the generally conical surface of the tip 17 the angle is 105.9° as shown in FIG. 6. At line C which is a futher rotation towards the trailing edge 45 of the flute 14 the angle is 95.9° and at line D which is at the trailing edge of the flutes 14 the angle is 83.5°.

In another embodiment (not shown) the head 14 may be in the form of a bugle head rather than a nut profile.

As used herein, the statement that the shank has a constant maximum radius is taken to mean that the radius of the shank is such that when rotated about the axis of the shank, it circumscribes an area which is of constant circular shape in cross section of the shank. Thus, a bore formed by the cutting edge 35 of the screw will have the same diameter as the shank away from the flutes, along substantially its entire depth of the bore.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the terms “comprise”, “comprises” or “comprising”, “include”, “including” and “having” are used in an inclusive sense, i.e. to specify the presence of the stated features but not to preclude the presence or addition of further features in various embodiments of the invention.

What is claimed is:

1. A screw, comprising:
a shank;
a head at one end of the shank and a tip at the other end of the shank, the shank having an outer surface, the shank being of substantially constant maximum radius between the head and the tip;
a drill section formed on the shank and extending from the tip to an intermediate position between the tip and the head, the drill section having at least one flute defining a bore cutting edge at the tip of the shank which extends from a radially inner position with respect to said shank to the outer surface of the shank;
a screw thread formed on the outer surface between the head and the tip and terminating at the bore cutting edge; and
the flute further forming a flute edge which intersects the screw thread between the tip and the intermediate position to form at least one thread tapping surface on the screw thread where the flute edge intersects the thread, so that when the screw is screwed into a work piece, the bore cutting edge drills a bore having a diameter substantially equal to the cross-sectional size of the shank, and the thread tapping surface cuts into the work piece to tap the bore and engage the screw thread with the work piece.

2. The screw of claim 1 wherein the screw thread extends from the bore cutting edge to a second intermediate position between the tip and the head, and wherein the first intermediate position is between the tip and the second intermediate position.

3. The screw of claim 1 wherein the head is formed from a hexagonal profile and a flange, the hexagonal profile being for engagement by a tool to rotate the screw to drive the screw into the work piece.

4. The screw of claim 1 wherein the cutting edge forms a plurality of thread tapping surfaces on the thread.

5. The screw of claim 1 wherein the drill section is provided with two flutes which form two bore cutting edges and two sets of thread tapping surfaces where the flute edges intersect the thread between the tip and the intermediate position.

6. The screw of claim 1 wherein the tip is defined by a generally conical surface which has an apex, and the bore cutting edge extend from the apex to the outer surface of the shank, and at least one of the thread tapping surfaces having a thread tapping edge which is a continuation of the bore cutting edge but formed at a different angle to the bore cutting edge.

7. The screw of claim 6 wherein the conical surface is formed as a clearance surface which falls away from the bore cutting edge so the clearance surface does not make contact with the work piece when a bore is being drilled.

8. The screw according to claim 1 wherein the tip is provided with a clearance surface which falls away from the bore cutting edge so the clearance surface does not make contact with the work piece as a bore is being cut into the work piece by the bore cutting edge.

9. The screw according to claim 1 wherein the tip has a clearance surface which forms a cone angle of about 110° at the cutting edge and reduces gradually to a cone angle of about 83.5° at a trailing edge of the flute.

10. A self tapping screw comprising:
a head;
a tip;
a shank having an outer surface;
a screw thread projecting outward from the outer surface of the shank and extending from a start location between the head and the tip to the tip, the shank having a constant maximum radius at least from the start location to the tip;
a drill section generally at the tip of the screw, the drill section being defined by at least one flute formed in the tip and the shank, the flute defining a cutting edge on the tip for forming a bore having a diameter equal to the diameter of the shank from the start location to the tip;
the flute further defining a thread tapping edge at the intersection of the flute with the thread at a position nearest to the tip.

11. The screw of claim 10 wherein the tip is defined by a generally conical surface which has an apex, and the bore cutting edge extends from the apex to the outer surface of the shank, and wherein the thread tapping edge comprises a continuation of the bore cutting edge but formed at a different angle to the bore cutting edge.

12. The screw of claim 11 wherein the conical surface is formed as a clearance surface which falls away from the bore cutting edge so the clearance surface does not make contact with the work piece when a bore is being drilled.

13. The screw according to claim 10 wherein the tip is provided with a clearance surface which falls away from the bore cutting edge so the clearance surface does not make contact with the work piece as a bore is being cut into the work piece by the bore cutting edge.

14. The screw according to claim 13 wherein the clearance surface has an angle with respect to a line perpendicular to the axis of the shank which is greater than the angle of the thread with respect to that perpendicular line.

15. The screw according to claim 10 wherein the tip has a clearance surface which forms a cone angle of about 110° at the cutting edge and reduces gradually to a cone angle of about 83.5° at a trailing edge of the flute.
